(19) United States
(12) Patent Application Publication
(10) Pub. No.: US 2024/0367463 A1
(43) Pub. Date: Nov. 7, 2024

(54) PNEUMATIC VEHICLE TYRE

(71) Applicant: Continental Reifen Deutschland GmbH, Hannover (DE)

(72) Inventors: Stephan Herbst, Langenhagen (DE); Fabian Zimmermann, Wennigsen (DE); Stefan Rittweger, Garbsen (DE)

(73) Assignee: Continental Reifen Deutschland GmbH, Hannover (DE)

(21) Appl. No.: 18/690,642

(22) PCT Filed: Jul. 26, 2022
(86) PCT No.: PCT/DE2022/200170

§ 371 Date: Mar. 8, 2024

(30) Foreign Application Priority Data
Sep. 10, 2021 (DE) 10 2021 210 020.1

(51) Int. Cl. B60C 11/13; B60C 11/03

(52) U.S. Cl. CPC B60C 11/1353; B60C 2011/0353; B60C 2011/1361

(57) ABSTRACT

The invention relates to a pneumatic vehicle tire with a tread with at least one circumferential groove, which is formed to the profile depth and has a groove base and groove flanks, wherein free-standing webs, which are at a distance from one another in the circumferential direction, are elongate in the circumferential direction and have a top surface running parallel to the tread periphery and a height of 7% to 30% of the profile depth, are formed on the groove base, wherein at least one protrusion, which sits on the groove base and is elongate in the circumferential direction, is formed between successive webs in the circumferential direction on and along each groove flank, wherein the one protrusion overlaps the other protrusion with respect to the circumferential direction, at least in portions, so that between the protrusions there remains a groove-base channel, which has a constant width in the axial direction between protrusion edges which are formed on the protrusions and run at a constant depth and in the circumferential direction.

### CROSS-REFERENCE TO RELATED APPLICATIONS

The present application is a National Stage Application under 35 U.S.C. § 371 of International Patent Application No. PCT/DE2022/200170 filed on Jul. 26, 2022, which claims priority from German Patent Application No. 10 2021 210 020.1 filed on Sep. 10, 2021, the disclosures of which are herein incorporated by reference in their entireties.

### BRIEF SUMMARY

The invention relates to a pneumatic vehicle tire with a tread with at least one circumferential groove, which is formed to the profile depth and has a groove base and groove flanks, wherein free-standing webs, which are at a distance from one another in the circumferential direction, are elongate in the circumferential direction and have a top surface running parallel to the tread periphery and a height of 7% to 30% of the profile depth, are formed on the groove base, wherein at least one protrusion, which sits on the groove base and is elongate in the circumferential direction, is formed between successive webs in the circumferential direction on and along each groove flank, wherein the one protrusion overlaps the other protrusion with respect to the circumferential direction, at least in portions, so that between the protrusions there remains a groove-base channel, which has a constant width in the axial direction between protrusion edges which are formed on the protrusions and run at a constant depth and in the circumferential direction.

Such a tire is known for example from EP 3 620 311 B1. The pneumatic vehicle tire has a tread with a circumferential groove, formed on the groove base of which are free-standing webs, which are at a distance from one another in the circumferential direction, are elongate in the circumferential direction, act as stone ejectors and have a height of 10% to 30% of the profile depth, a width of 25% to 40% of the width of the circumferential groove and a maximum circumferential length, projected in the circumferential direction, of 16.0 mm to 25.0 mm. On the side of each web, the groove edges of the circumferential groove are beveled in portions, wherein the bevels overhang the web in the circumferential direction, at least on one side. Preferably, two protrusions which are elongate in the circumferential direction are in each case formed at the groove flanks in the area between the webs. The bevels increase the groove cross section in portions, which improves the water drainage properties and reduces the likelihood of stones becoming caught in the area of the webs. The elongate protrusions thus interact with the webs in a way that is advantageous for the stone-ejecting effect.

In the case of tires of the type mentioned at the beginning, catching stones, or “stone trapping”, may still occur in the circumferential grooves when driving off-road, especially when driving on gravel roads. In the case of tires for SUVs, which are often also driven off-road, it is particularly important when designing webs positioned in the circumferential grooves and acting as stone ejectors also to pay attention to their effect on the water drainage capacity of the circumferential grooves in order to ensure a continued good aquaplaning performance when driving on wet, asphalted roads.

The object of the invention is to reduce further the risk of catching stones in circumferential grooves in a pneumatic vehicle tire of the type mentioned at the beginning, while maintaining a good aquaplaning performance.

According to the invention, the object set is achieved by each web being locally widened on each side in the middle by an outwardly rounded side part, which is partly delimited by the top surface of the web, wherein the one side part lies opposite the other side part and wherein the web has at the side parts a maximum width, determined in the axial direction at the level of the top surface, of at most 100% of the width of the groove-base channel.

The side parts, which widen the web in the middle, stabilize the web laterally and counteract a deformation of the web by stones pressing into the circumferential groove, thereby further reducing the likelihood of catching stones. Due to the side parts, which in plan view are rounded outwardly in the direction of groove flanks, a low-turbulence water flow can continue to occur in the area of the webs when driving on wet road surfaces. Since the width of the webs in the area of the side parts is at most 100% of the width of the groove-base channels which are located between the protrusions connected to the groove flanks, a high water drainage capacity in the circumferential groove, and thus a good aquaplaning performance, is maintained.

According to a preferred design, the maximum width of the web is at least 70%, preferably 80% to 90%, of the width of the groove-base channel. A maximum width of at least 70% is particularly favorable with regard to the stone-repelling effect of the web. The specified preferred range for the maximum width further improves the stone-repelling effect of the web, a maximum width of at most 90% ensuring a particularly low-turbulence water flow in the transitional area between the groove-base channel and the groove passages remaining on the groove flanks at the sides of the web.

Preferably, the constant width of the groove-base channel is 45% to 65%, in particular 50% to 60%, of the width of the circumferential groove at the tread periphery. This measure also contributes to maintaining a good aquaplaning performance.

According to a further preferred design, the web has in the area outside its side parts a width, determined in the axial direction at the level of the top surface, which is at least 0.5 mm, in particular 1.0 mm to 1.5 mm, smaller than the maximum width of the web present in the area of the side parts. This contributes to maintaining a good aquaplaning performance and at the same time reducing the risk of catching stones in the circumferential groove.

A further preferred design is characterized in that the side parts are positioned symmetrically in relation to one another with respect to a longitudinally sectional center plane of the web defined by the circumferential direction and the radial direction. Such a symmetrical positioning of the side part improves the stabilizing effect of the side parts on the web against deformation by stones pressing into the circumferential groove, and thus contributes to a further reduction in the risk of catching stones.

Furthermore, it is preferred if the side parts are symmetrically formed with respect to a cross-sectional center plane of the web defined by the axial direction and the radial direction. Such side parts ensure a particularly uniform, and therefore advantageous, stabilization of the web, and therefore also contribute to a further reduction in the risk of catching stones.

According to a further preferred design, the web has a maximum circumferential length, determined at the level of the top surface and projected in the circumferential direction, of 8.0 mm to 12.0 mm.

The height of the web is preferably 10% to 20% of the profile depth.

In particular, the protrusions on the groove flank have a maximum circumferential length of 18.0 mm to 25.0 mm.

A further preferred design is characterized in that, on the sides of each web, the groove flanks are provided with bevels, which run to the tread periphery, overhang the web in the circumferential direction, at least on one side, run at an angle of 30° to 55°, in particular of 40° to 50°, in relation to the radial direction and have a width of 1.2 mm to 2.0 mm and a circumferential length of 18.0 mm to 25.0 mm. Such bevels are already known from EP 3 620 311 B1 mentioned at the beginning. They increase the groove cross section in portions, which further improves the water drainage properties and further reduces the likelihood of stones becoming caught in the area of the webs.

Further features, advantages and details of the invention will now be described in more detail with reference to the drawing, which schematically shows an exemplary embodiment of the invention. In the drawing:

### BRIEF SUMMARY OF DRAWINGS

FIG. 1 shows a plan view of a shoulder-side cut-out of a tread flattened onto a plane of a pneumatic vehicle tire with a design variant of the invention,

FIG. 2 shows an enlarged plan view of the detail Z₂ of FIG. 1,

FIG. 3 shows a section along the line III-III of FIG. 2,

FIG. 4 shows a section along the line IV-IV of FIG. 2 and

FIG. 5 shows a section along the line V-V of FIG. 2.

### DETAILED DESCRIPTION

Pneumatic vehicle tires designed according to the invention are tires for motor vehicles, in particular for multi-track motor vehicles, and preferably radial tires for passenger cars, vans, light trucks (small delivery trucks with a permissible gross vehicle weight of ≤3.5 t, light trucks with a permissible gross vehicle weight of ≤7.5 t) or SUVs.

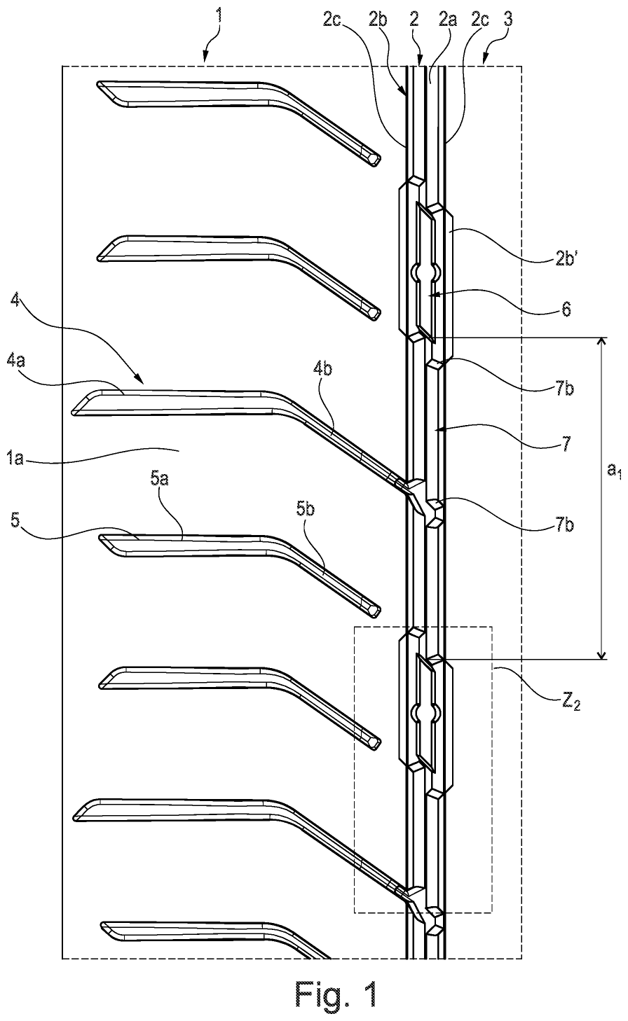

FIG. 1 shows a plan view of a cut-out of a tread with a shoulder-side profile rib 1, which is separated from a further, only schematically indicated, circumferential profile rib 3 by a shoulder-side circumferential groove 2 running straight in plan view.

The shoulder-side profile rib 1 is provided with a multiplicity of transverse grooves 4, which lead into the circumferential groove 2 and lend the shoulder-side profile rib 1 block-like rib elements 1a, wherein two evenly distributed transverse grooves 5 that end before the circumferential groove 2 are formed in each rib element 1a. The transverse grooves 4, 5 run parallel to one another, when viewed in plan view, and are respectively made up of a transverse groove portion 4a (transverse groove 4), 5a (transverse groove 5) on the outer side of the tread, running in the axial direction in plan view, and a transverse groove portion 4b (transverse grooves 4), 5b (transverse grooves 5) on the inner side of the tread, running at an angle of 25° to 45° in relation to the axial direction in plan view.

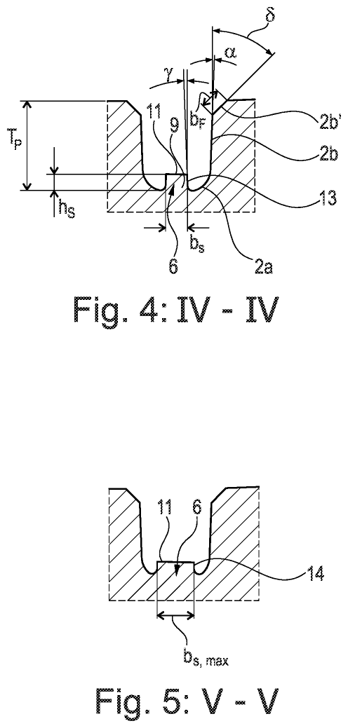

The circumferential groove 2 has a groove base 2a, two groove flanks 2b and two groove edges 2c running straight in plan view and beveled in portions, so that the groove flanks 2b are adjoined by bevels 2b′ running to the tread periphery, still to be discussed in further detail. When viewed in cross section, the groove flanks 2b run at an angle α (FIG. 3, FIG. 4) of 0° to 5° in relation to the radial direction. When viewed in cross section, the groove base 2a is formed as rounded in a flat U-shaped manner (FIG. 4).

Free-standing bar-like webs 6, which are at a distance from the groove flanks 2b and are positioned in the middle of the circumferential groove 2, are formed on the groove base 2a in the circumferential groove 2, wherein successive webs 6 in the circumferential direction are at a distances a₁ from one another of 50.0 mm to 75.0 mm in the circumferential direction, determined as smallest possible distances. Furthermore, two bar-like protrusions 7, which sit on the groove base 2a and between which the transverse groove portions 4b of the transverse grooves 4 on the inner side of the tread enter the circumferential groove 2, are formed between successive webs 6 in the circumferential direction along each groove flank 2b. According to FIG. 3, the circumferential groove 2 has between its groove edges 2c, that is to say in the areas outside the bevels 2b′, a width B₁ of 6.0 mm to 8.0 mm and at the locations where it is free from webs 6 is formed in the radial direction to the intended profile depth T_{P}, which is preferably 6.5 mm to 13.0 mm, in particular up to 10.0 mm.

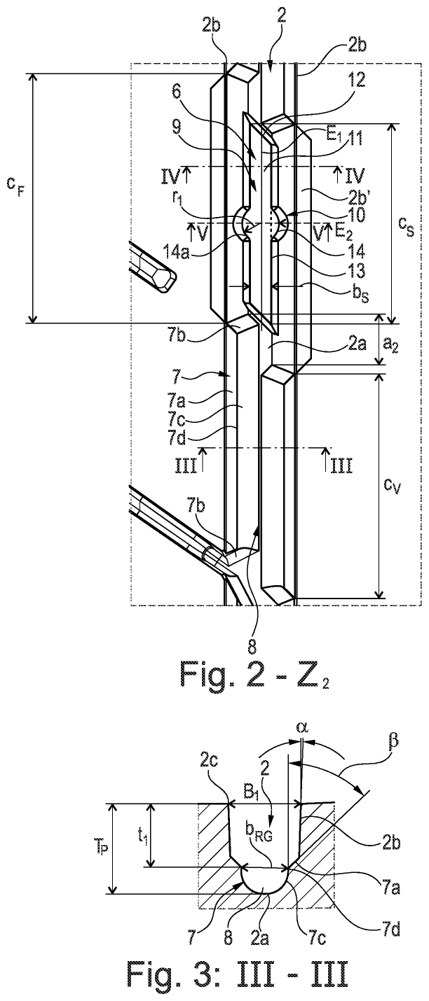

As shown in FIG. 2, the protrusions 7 formed on the one groove flank 2b are offset in relation to the protrusions 7 formed on the other groove flank 2b in the circumferential direction and have an offset a₂, determined in the circumferential direction between similarly positioned ends of the protrusions 7, of 3.0 mm to 5.0 mm. According to FIG. 2 and FIG. 3, each protrusion 7 is delimited in the radial direction by a top surface 7a, in the circumferential direction by two end surfaces 7b (FIG. 2) and laterally by a side surface 7c running to the groove base 2a. According to FIG. 3, the top surface 7a descends from the respective groove flank 2b in the direction of the middle of the circumferential groove 2 in the radial direction and, when viewed in the cross section oriented in the axial direction, runs at a constant angle β of 30° to 55°, in particular of 40° to 50°, in relation to the radial direction. According to FIG. 2, the end surfaces 7b are sloping in relation to the axial direction and inclined in opposite directions in relation to the axial direction in such a way that the protrusion 7 has at the level of the top surface 7a on the corresponding groove flank 2b a maximum circumferential length c_{V} (circumferential length at the longest point measured in the circumferential direction) of 18.0 mm to 25.0 mm, wherein the maximum circumferential length c_{V} is preferably at the same time 30% to 50%, particularly preferably up to 45%, of the aforementioned distance a₁ (FIG. 1) between the webs 6. As FIG. 3 also shows, when viewed in the cross section oriented in the axial direction, the side surface 7c is curved in the form of a circular arc, at least in portions, in such a way that it adjoins the groove base 2a continuously (without any sharp angles). In the exemplary embodiment shown, in those circumferential portions in which the side surface 7c of a protrusion 7 lying on the one groove flank 2b lies directly axially opposite the side surface 7c of a protrusion 7 lying on the other groove flank 2b, the side surfaces 7c also run to the groove base 2a. Alternatively, the side surfaces 7c in the aforementioned circumferential portions may adjoin one another at the profile depth Tₚ, so that the groove base 2a is missing in portions. The top surface 7a and the side surface 7c adjoin one another via a protrusion edge 7d, which in plan view runs in the circumferential direction (FIG. 2) and in the radial direction at a constant depth t₁ of 60% to 80%, in particular of 65% to 75%, of the profile depth T_{P}.

As FIG. 2 in combination with FIG. 3 shows, between protrusions 7 lying opposite one another in the axial direction there remains in each case a cross-sectionally U-shaped groove-base channel 8, which-depending on the design of the side surfaces 7c—is delimited either by opposing circumferential portions of the side surfaces 7c and the groove base 2a or exclusively by the opposing circumferential portions of the side surfaces 7c. According to FIG. 3, each groove-base channel 8 between the protrusion edges 7d has in the axial direction a constant width b_{RG} of 45% to 65%, in particular of 50% to 60%, of the width B₁ of the circumferential groove 2.

As FIG. 2 shows, in plan view each web 6 is elongate in the circumferential direction, is at equal distances from the groove flanks 2b in the axial direction and is made up of a middle part 9, which is parallelogram-shaped in plan view and formed in the middle in the circumferential groove 2, and two side parts 10, each of a smaller volume in comparison with the middle part 9 and axially adjoining the middle part 9 laterally (one of the side parts 10 is indicated by a dotted line).

The web 6 is delimited in the radial direction by a top surface 11, which is aligned parallel to the tread periphery, in the circumferential direction by end surfaces 12, which in plan view slope in relation to the axial direction, and axially laterally by side surfaces 13, which in plan view run in the circumferential direction and are interrupted in the area of the side parts 10. When viewed in the cross section oriented in the circumferential direction, the end surfaces 12 run at an angle of 0° to 3°, in particular of at least 1°, in relation to the radial direction (not shown). When viewed in the cross section oriented in the axial direction, the side surfaces 13 run at an angle γ (FIG. 4) of 1° to 3° in relation to the radial direction.

The side parts 10 lie directly opposite one another in the axial direction, separated by the middle part 9, and are positioned symmetrically in relation to one another with respect to a longitudinally sectional center plane E₁ of the web 6 defined by the circumferential direction and the radial direction. Furthermore, the side parts 10 are each formed symmetrically with respect to a cross-sectional center plane E₂ of the web 6 defined by the axial direction and the radial direction. The side parts 10 locally widen the web 6, are outwardly rounded and are delimited in the radial direction by the top surface 11 and also by a side surface 14, which adjoins the top surface 11 and in plan view runs in the form of a circular arc, wherein the two side surfaces 14—corresponding to the rounding of the side parts 10—are in plan view curved convexly in relation to one another and each side surface 14 has at the level of the top surface 11 a delimiting edge 14a running in the form of a circular arc. When viewed in the cross section running perpendicularly to the associated delimiting edge 14a in plan view, the side surfaces 14 run in the radial direction (FIG. 5) or at an angle of up to 2° in relation to this direction. The delimiting edges 14a of the two side surfaces 14 also run on a common radius r₁.

The web 6 has a maximum circumferential length c_{S}, determined at the level of the top surface 11 and projected in the circumferential direction, of 8.0 mm to 12.0 mm, in the radial direction a height h_{S} (FIG. 4), determined with respect to the level of the profile depth T_{P} and with reference to the top surface 11, of 7% to 30%, in particular of 10% to 20%, of the profile depth T_{P} (FIG. 4) and in the area of the side parts 10 a maximum width b_{S, MAX} (FIG. 5), determined in the axial direction on the top surface 11, of 70% to 100%, in particular of 80% to 90%, of the width b_{RG} of the groove-base channel 8 (FIG. 3). Furthermore, the web 6 has in the area outside the side parts 10 and the end surfaces 12 a constant width b_{S} (FIG. 4), determined in the axial direction on the top surface 11, which is at least 0.5 mm, in particular 1.0 mm to 1.5 mm, less than the maximum width b_{S, MAX} (FIG. 5).

As FIG. 2 also shows, the already mentioned bevels 2b′ adjoining the groove flanks 2b and running to the tread periphery are formed on the sides of the webs 6, so that there is a web 6 in each case in the area between the bevels 2b′. The bevels 2b′ are sloping surfaces which, when viewed in the cross section oriented in the axial direction, appear as straight lines, run at an angle δ (FIG. 4) of 35° to 55°, in particular of 45° to 50°, in relation to the radial direction and have a width b_{F} (FIG. 4) of 1.2 mm to 2.0 mm and a maximum circumferential length c_{F} of 18.0 mm to 25.0 mm. The bevels 2b′ formed on the one groove flank 2b are offset in the circumferential direction from the bevels 2b′ formed on the other groove flank 2b, wherein the bevel 2b′ located on the one groove flank 2b “overlaps” the bevel 2b′ located on the other groove flank 2b—in relation to the circumferential direction—in portions. The one bevel 2b′ overhangs the web 6 in one circumferential direction and the other bevel 2b′ overhangs the web 6 in the other circumferential direction. The offset determined between the bevels 2b′ is equal to the aforementioned offset a₂ of the protrusions 7.

The invention is not limited to the exemplary embodiment described. The bevels are optional. The number of protrusions in the area between successive free-standing webs in the circumferential direction may be in particular one to three on each groove flank. The circumferential groove provided with webs and protrusions may be a central circumferential groove, i.e. a circumferential groove which separates central profile ribs from one another.

### LIST OF REFERENCE SIGNS

1 Shoulder-side profile rib
1a Rib element
2 Shoulder-side circumferential groove
2a Groove base
2b Groove flank
2b Bevel
2c Groove edge
3 Profile rib
4 Transverse groove
4a Transverse groove portion on the outer side of the tread
4b Transverse groove portion on the inner side of the tread
5 Transverse groove
5a Transverse groove portion on the outer side of the tread
5b Transverse groove portion on the inner side of the tread
6 Web
7 Protrusion
7a Top surface
7b End surface
7c Side surface
7d Protrusion edge
8 Groove-base channel
9 Middle part
10 Side part
11 Top surface
12 End surface
13 Side surface
14 Side surface
14a Delimiting edge
a₁ Distance
a₂ Offset
B₁ Width
b_{RG} Width
b_{S} Width
b_{S, MAX} Maximum width
c_{F}, c_{S}, c_{V} Maximum circumferential length
E₁ Longitudinally sectional center plane
E₂ Cross-sectional center plane
h_{S} Height
r₁ Radius
t₁ Depth
T_{P} Profile depth
Z₂ Detail
α, β, γ, δ Angle

1-10. (canceled)

11. A pneumatic vehicle tire comprising:
a tread with a circumferential groove, is formed to a profile depth (T_{P}), and has a groove base and groove flanks (2b);
free-standing webs, which are at a distance from one another in a circumferential direction, are elongate in the circumferential direction and have a top surface running parallel to a tread periphery and a height (h_{S}) of 7% to 30% of the profile depth (T_{P}), are formed on the groove base;
at least one protrusion, which sits on the groove base and is elongate in the circumferential direction, is formed between successive webs in the circumferential direction on and along each groove flank;
one protrusion of the at least one protrusion overlaps other protrusions with respect to the circumferential direction, so that between the protrusions there remains a groove-base channel, which has a constant width (b_{RG}) in an axial direction between protrusion edges which are formed on the protrusions and run at a constant depth (t₁) and in the circumferential direction; and
wherein each web is locally widened on each side in the middle by an outwardly rounded side part, which is partly delimited by a top surface of the web, wherein one side part lies opposite an other side part and wherein the web has at the side parts a maximum width (b_{S, MAX}), determined in the axial direction at the level of the top surface, of at most 100% of the width (b_{RG}) of the groove-base channel.

12. The pneumatic tire of claim 1, wherein the maximum width (b_{S, MAX}) of the web is at least 70%, preferably 80% to 90%, of the width (b_{RG}) of the groove-base channel.

13. The pneumatic tire of claim 1, wherein the constant width (b_{RG}) of the groove-base channel is 45% to 65%, in particular 50% to 60%, of the width (B₁) of the circumferential groove at the tread periphery.

14. The pneumatic tire of claim 1, wherein the web has in the area outside its side parts a width (b_{S}), determined in the axial direction at the level of the top surface, which is at least 0.5 mm, in particular 1.0 mm to 1.5 mm, smaller than the maximum width (b_{S, MAX}) of the web present in the area of the side parts.

15. The pneumatic tire of claim 1, wherein the side parts are positioned symmetrically in relation to one another with respect to a longitudinally sectional center plane (E₁) of the web defined by the circumferential direction and the radial direction.

16. The pneumatic tire of claim 1, wherein the side parts are formed symmetrically with respect to a cross-sectional center plane (E₂) of the web defined by the axial direction and the radial direction.

17. The pneumatic tire of claim 1, wherein the web has a maximum circumferential length (c_{S}), determined at the level of the top surface and projected in the circumferential direction, of 8.0 mm to 12.0 mm.

18. The pneumatic tire of claim 1, wherein the height (h_{S}) of the web is 10% to 20% of the profile depth (T_{P}).

19. The pneumatic tire of claim 1, wherein the protrusions on the groove flank have a maximum circumferential length (c_{V}) of 18.0 mm to 25.0 mm.

20. The pneumatic tire of claim 1, wherein on the sides of each web, the groove flanks are provided with bevels (2b′), which run to the tread periphery, overhang the web in the circumferential direction, at least on one side, run at an angle (δ) of 30° to 55°, in particular of 40° to 50°, in relation to the radial direction and have a width (b_{F}) of 1.2 mm to 2.0 mm and a circumferential length (c_{F}) of 18.0 mm to 25.0 mm.
